(19) United States
(12) Patent Application Publication
(10) Pub. No.: US 2025/0054051 A1
(43) Pub. Date: Feb. 13, 2025

(54) METHOD FOR SYNCHRONIZING ORDER INFORMATION AND E-COMMERCE ENTERPRISE RESOURCE PLANNING

(71) Applicant: SHENZHEN MEIYUNJI NETWORK TECHNOLOGY CO., LTD., Shenzhen (CN)

(72) Inventors: Zhichao WANG, Shenzhen (CN); Xiaoxin CHEN, Shenzhen (CN); Peng CHEN, Shenzhen (CN); Zenghui YE, Shenzhen (CN); Shoubao CHEN, Shenzhen (CN)

(73) Assignee: SHENZHEN MEIYUNJI NETWORK TECHNOLOGY CO., LTD., Shenzhen (CN)

(21) Appl. No.: 18/797,706

(22) Filed: Aug. 8, 2024

(30) Foreign Application Priority Data
Aug. 11, 2023 (CN) 2023110124103

(51) Int. Cl. G06Q 30/0601; G06Q 10/087

(52) U.S. Cl. CPC G06Q 30/0635; G06Q 10/087

(57) ABSTRACT

A method for synchronizing order information and an e-commerce ERP. The method is applied to an order management module of e-commerce ERP, and the order management module includes an order template, and the method includes: obtaining data access authorities of an order information interface and a notification information interface of an e-commerce platform; when an order status changes, receiving, by the order management module, the second order information, and filling the second order information into the order template to generate target order information synchronized at that time; synchronizing, by the order management module, the first order information from the order information interface at interval time t1, and filling the first order information synchronized each time into the order template to generate target order information synchronized at that time; and configuring target order information newly generated in the order template as synchronized target order information.

### CROSS-REFERENCE TO RELATED APPLICATIONS

This application claims priority to Chinese Patent Application No. 202311012410.3, all filed on Aug. 11, 2023, the entire contents of which are incorporated herein by reference.

### TECHNICAL FIELD

The present application relates to the technical field of computers, and in particular to a method for synchronizing order information and a system thereof.

### BACKGROUND

With the rise of global e-commerce, international retail trade has developed rapidly, and a large number of domestic small and medium-sized e-commerce sellers have expanded their retail business to foreign markets. With the development of cross-border business, the e-commerce enterprise resource planning (ERP) system (referred to as e-commerce ERP) developed based on ERP software has gradually developed. E-commerce ERP can be deeply connected with the e-commerce platform, helping domestic small and medium-sized e-commerce sellers to uniformly manage their overseas stores, which solves the obstacles caused by language differences, and enables one operator to manage hundreds of e-commerce stores simultaneously, thereby greatly improving the efficiency of store operations.

E-commerce ERP accesses and controls the stores of the e-commerce platform through established rules, processes dynamic data in all aspects of store operations, and has complex data management. In addition, it must meet the operational convenience requirements of various types of users (sellers). Therefore, the various functional modules of the existing commercialized e-commerce ERP are still in the stage of gradual functional update and improvement. The functional algorithms and rules formulated by various software companies when developing their own e-commerce ERP are different. Each functional module will continue to develop new versions as user needs change to be compatible with more usage scenarios.

The existing e-commerce ERP mainly synchronizes (obtains) the commodity order information of the corresponding store from the e-commerce platform through the order information interface of the e-commerce platform. The order information is usually synchronized once every 15 minutes, and the synchronization interval time of the order information is long. If the synchronization interval time of the order information is shortened (the synchronization frequency of the order information is increased), there will be a problem of the order information interface exceeding the limit, which will cause a significant delay in the update of the order information, and even the order status and fees of some orders cannot be updated.

This order information obtaining method using a single interface (referring to the order information interface) will cause abnormalities in the order information synchronized from the order information interface, such as insufficient order export time, order backlog, and missing order, when the number of orders increases to a certain number (such as the peak period of orders). Moreover, the delay in order information synchronization will further bring a series of linkage problems (such as failure to send marketing emails, and failure to stop the delivery of cancelled orders in time), which will bring many uncertain risks and unnecessary losses to order processing.

Other technical issues related to the present application will be further described later. The above contents are only used to assist in understanding the technical solution of the present application, and do not mean that all of the above contents fall in the related art.

### SUMMARY

The main purpose of the present application is to provide a method for synchronizing order information and a system, aiming to shorten the synchronization time of order information, achieve synchronization of order information in seconds, and improve the stability and security of order information synchronization.

In view of above objectives, the present application provides a method for synchronizing order information, applied to an order management module of e-commerce enterprise resource planning (ERP). The order management module includes an order template, and the method includes following steps.

Step S1, obtaining data access authorities of an order information interface and a notification information interface of an e-commerce platform, creating, by the order management module, a subscription notification of order status information based on the notification information interface. The order information interface is configured to obtain first order information from the e-commerce platform, and the notification information interface is configured to obtain second order information from the e-commerce platform.

Step S2, obtaining the second order information according to step S21, obtaining the first order information according to step S22, and generating corresponding target order information. The step S2 includes:

step S21, in response to that an order status changes, receiving, by the order management module, a corresponding order status information notification from the notification information interface, extracting order information in an order status information notification as the second order information, and filling the second order information into the order template to generate target order information synchronized from the notification information interface at that time;

step S22, synchronizing, by the order management module, the first order information from the order information interface at interval time t1, and filling the first order information synchronized each time into the order template to generate target order information synchronized from the order information interface at that time; and

step S3, configuring target order information newly generated in the order template as synchronized target order information.

Other technical features and technical effects of the present application are described in the latter part of the specification. The solving ideas for the technical problem and related product design solutions of the present application are as follows.

The order information of the existing e-commerce platform is synchronized to the e-commerce ERP through the order information interface (defined as the first interface). Taking the Amazon e-commerce platform as an example, Amazon's order information interface is Amazon OrderItems API. Since Amazon OrderItems API does not support batch requests, it can only be requested one by one for a single order.

In order to avoid the order information interface being over the limit, it is necessary to extend the synchronization interval time of the order information, which is usually requested for synchronization once every 15 minutes. This conventional order information synchronization method will result in following issues. Firstly, sellers cannot obtain the latest sales data in time, which is not conducive to providing more accurate operation strategies and decision support. Secondly, sellers cannot get the order profit situation in the first time, and there is a lag of about 15 minutes, which is not conducive to timely discovering abnormal order profits and may even cause losses. Thirdly, for orders that require sellers to ship, since the buyer cancels the transaction and the order is not updated in time, the seller will waste time shipping and even losses in goods costs and logistics costs will be caused.

In order to shorten the synchronization interval time of order information, the solution of some e-commerce ERP is to increase the synchronization frequency of order information and frequently pull orders in scheduled tasks. In this case, due to the high frequency of order information requests, there will be a risk of the order information interface being over the limit, which will lead to problems, such as significant delays in the update of order data (order information) or missing order data. This solution of increasing the synchronization frequency of order information cannot fundamentally solve the problem that the order information interface is over the limit, and the stability and security of the synchronized order information are very poor.

The applicant found that recently an e-commerce platform provides a notification information interface (defined as the second interface) service, which can track the status of each activity through the notification information interface and send relevant notifications when the activity status changes. Taking Amazon e-commerce platform as an example, Amazon's notification information interface is Amazon Notifications API. Amazon Notifications API supports multiple protocols, endpoints and topic types, which can be flexibly configured and customized according to the needs of specific application scenarios, and can not only automatically monitor specific events and activity status changes, but further can trigger related operations or processing processes, making the entire system process more smooth and automated. Since the Amazon Notifications API is hosted on the Amazon e-commerce platform, the notification information interface will not exceed the limit and can further achieve real-time response to notification information.

However, Amazon's notification information interface cannot output direct order information like the order information interface, and can only output corresponding status information when the activity status changes. The applicant further found that based on the notification information interface, it is possible to programmatically create subscription notifications and receive notifications timely, thereby obtaining response feedback on changes in order status. That is, when the seller's order status changes, notification information feedback will be immediately triggered, and order status information can be received in real time (instantly) through the notification information interface. Taking the Amazon e-commerce platform as an example, Amazon's notification information interface (Amazon Notifications API) recently added an order status change (ORDER STATUS CHANGE) notification interface, which will be triggered when the seller's order status changes, so as to output a notification of order status change from the notification information interface. According to the change information of order status, the next status of the order can be inferred according to the order type (such as self-delivery order, consignment delivery order, and the like).

Based on the above analysis, the applicant provides an order management module on the e-commerce ERP, and obtains the data access authorities of the order information interface and the notification information interface of the e-commerce ERP through the order management module. In addition, the order management module synchronizes order information from the order information interface of the e-commerce platform at interval time t1, and the order information synchronized from the order information interface of the e-commerce platform is defined as the first order information. That is, the first order information is detailed commodity order information, including order number, order status, order time, order commodity information, order amount, buyer information (such as buyer name and buyer contact information), delivery information (such as recipient, delivery address) and other order information. The first order information synchronized each time is filled into the order template of the order management module (that is, the target order information in the order template is updated) to generate the target order information synchronized from the order information interface. The target order information is used as the actual effective order information for executing order-related operations in the e-commerce ERP.

In addition, the order management module creates a subscription notification for the order status information based on the notification information interface. In response to changes in the order status, the e-commerce platform outputs a notification of the change in the order status through the notification information interface. That is, when the order status changes, the order management module automatically receives the order status change notification (including order status information and order update time) from the notification information interface, extracts the order information in the order status information notification as the second order information, and fills the second order information into the order template of the order management module (that is, the target order information in the order template is updated) to generate the target order information synchronized from the notification information interface. In this case, the second order information only includes a small amount of order information such as the order number, order status, and part of the order commodity information (such as the online commodity code MSKU and the order commodity quantity), but does not include the buyer information, delivery information, detailed order commodity information (such as the commodity number ASIN and the commodity specification attributes), and the like.

Based on the target order information synchronized by the order information interface and the target order information synchronized by the notification information interface, the newly generated target order information is used as the target order information synchronized back from the e-commerce platform. This order synchronization method can update and cover the target order information before the order status changes through the second order information that responds quickly after the first order information is obtained for the first time, so that the order information synchronization time is greatly shortened and the order information is synchronized in seconds. Therefore, the target order information can be used in advance to execute order operations (such as sending information to buyers, updating order delivery information, tracking order progress, and the like).

Furthermore, the commodity information in the first order information is defined as the first commodity information (the first commodity information is detailed commodity information), the commodity information in the second order information is defined as the second commodity information (the second commodity information only includes a small amount of commodity information), and the commodity information stored in the commodity module of the e-commerce ERP is defined as the third commodity information (the third commodity information is temporary commodity information). Since there may be a deviation between the commodity information in the commodity module and the actual order commodity information, the third commodity information is used as reference data for the order commodity information and is temporary commodity information. In the order template, the priority of the third commodity information is lower than that of the first commodity information. That is, before the first order information is obtained, the third commodity information is temporarily filled into the order template, so that the commodity information of the target order information in the order template is complete, making up for the defect that the second order information only includes a small amount of order information.

This order synchronization method and the corresponding e-commerce ERP system can obtain temporary order information in advance before the first order information is obtained, and the order pulling or updating time has been changed from once every 15 minutes to about 10-20 seconds in which once the buyer completes the transaction, the order can be pulled to e-commerce ERP, realizing the synchronization of order information in seconds. Compared with the existing synchronization method of e-commerce ERP (synchronization every 15 minutes), the new second-level synchronization method include following advantages. Firstly, sellers can obtain the latest sales data in advance and make operational strategies and decision support conforming with the actual situation based on the latest data. Secondly, sellers can get the order profit situation in advance, which is conducive to timely discovering abnormal order profits and avoiding losses. Thirdly, orders are updated in time. If the buyer cancels the transaction, the seller can find it in time to avoid losses in the seller's goods cost and logistics cost.

In addition, the new second-level synchronization method and the e-commerce ERP system can further enhance user time perception, improve user operation experience, and improve the operation efficiency of e-commerce ERP. Since the new solution has used the notification information interface as an auxiliary order information interface, the synchronization interval time t1 of the order information interface can be extended (for example, synchronization once every 30 minutes) to avoid the order information interface from exceeding the limit due to excessive order numbers. Moreover, since more stable order data can be obtained through the notification information interface, the second order information can be further used to determine whether there is a missing order in the order information interface, so as to improve the stability and security of order information synchronization.

Further, the present application further provides a system, including functional modules, such as commodity module, sales module, procurement module, logistics module, warehouse module, financial module, advertising module, customer service module or tool module, and executing various operating instructions of corresponding functional modules. Correspondingly, the present application further provides a server, including a memory and a processor. Each functional module and its system in the present application are stored in the memory, and the processor can execute the operating instructions of the corresponding functional module and its system. In addition, the present application further provides a computer device, including a memory and a processor. Each functional module and its system in the present application are stored in the memory, and the processor can execute the operating instructions of the corresponding functional module and its system.

Statement, as shown in FIG. 1, the e-commerce ERP system of the present application includes one or more functional modules, such as commodity module, sales module, procurement module, logistics module, warehouse module, financial module, advertising module, customer service module, tool module, authority management module and data module. The functional modules of the present application can be combined with each other, or they can exist independently, or one functional module can be a sub-module of another functional module. The operators of the e-commerce ERP in the present application can further be called store managers, sellers, merchants, operators, users, and their identities are not strictly limited unless otherwise stated. In the present application, “commodity” and “product” are both customary names in this field, and the two names have the same meaning and will not be distinguished. In the present application, “e-commerce platform” is the abbreviation of “e-commerce platform system”. In the present application, the first interface, the second interface and the third interface are divided according to the interface function. In actual application, multiple interfaces can be merged into the same interface, and the merged common interface realizes the functions corresponding to the interfaces before merging.

The meaning and description of terms in the e-commerce field in the present application (the letters of English words in the present application are not case-sensitive) are illustrated as follows.
(1) Enterprise Resource Planning (ERP) is the enterprise resource planning, which can be used as the abbreviation of ERP system in the present application.
(2) Amazon Order Items API refers to Amazon order information interface, where API (Application Programming Interface) refers to application program interface. Amazon Notifications API refers to the Amazon notification information interface; ORDER STATUS CHANGE refers to the order status change.
(3) Amazon standard identification number (ASIN) is the commodity number of the Amazon platform, which generally refers to the commodity number of the e-commerce platform in the present application. Stock Keeping Unit (SKU) refers to the commodity code of the inventory commodity. Standard Product Unit (SPU) refers to the standardized product unit. Merchant Stock Keeping Unit (MSKU) refers to the commodity code of the online commodity. Fulfillment Network Stock Keeping Unit (FNSKU) refers to the distribution network inventory unit, that is, the commodity label code of the commodity when being shipped.

### BRIEF DESCRIPTION OF THE DRAWINGS

The accompanying drawings are used to provide a further understanding of the present application and do not constitute a limitation to the present application. The contents shown in the accompanying drawings may be real data of the embodiments and belong to the scope of the present application. The accompanying drawings include following figures.

FIG. 1 is a schematic diagram of functional modules of the e-commerce ERP system according to an embodiment of the present application.

FIG. 2 is a schematic diagram of the principle of the method for synchronizing order information according to an embodiment of the present application.

FIG. 3 is a schematic structural diagram of the order management module according to an embodiment of the present application.

FIG. 4 is a schematic flowchart of the method for synchronizing order information according to an embodiment of the present application.

### DETAILED DESCRIPTION OF THE EMBODIMENTS

In order to make the purpose, technical solution and advantages of the present application more clear, the following will further detailedly describe embodiments of the present application through specific implementation methods combined with the accompanying drawings. It should be understood that the specific embodiments described here are only used to explain the present application and are not used to limit the present application.

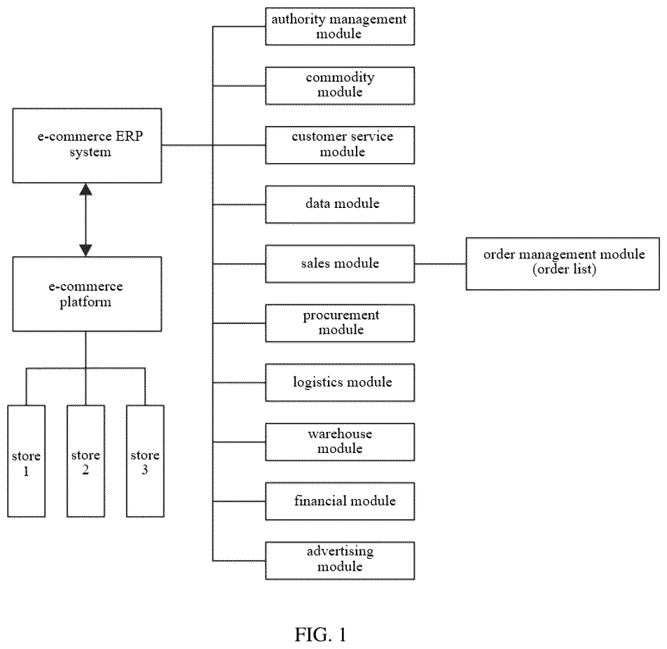

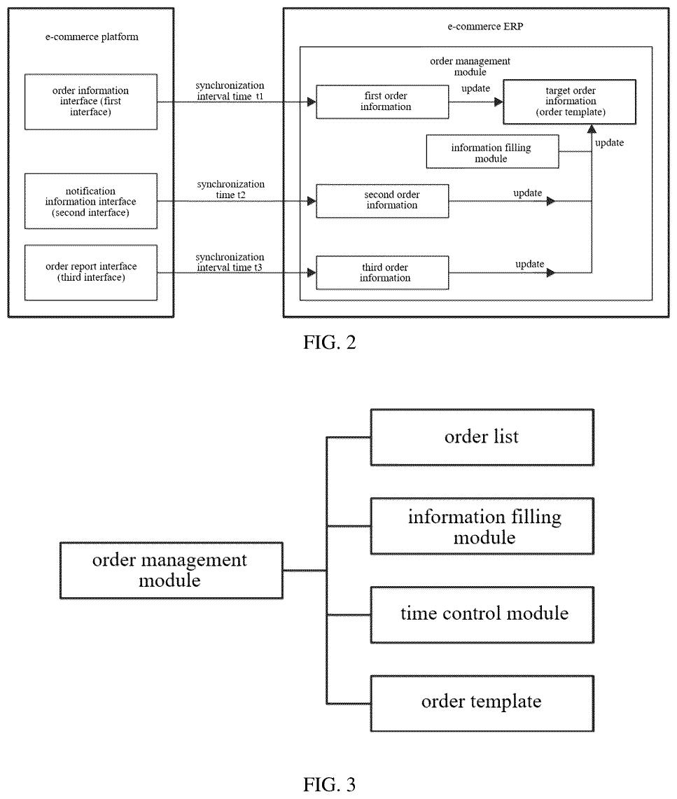

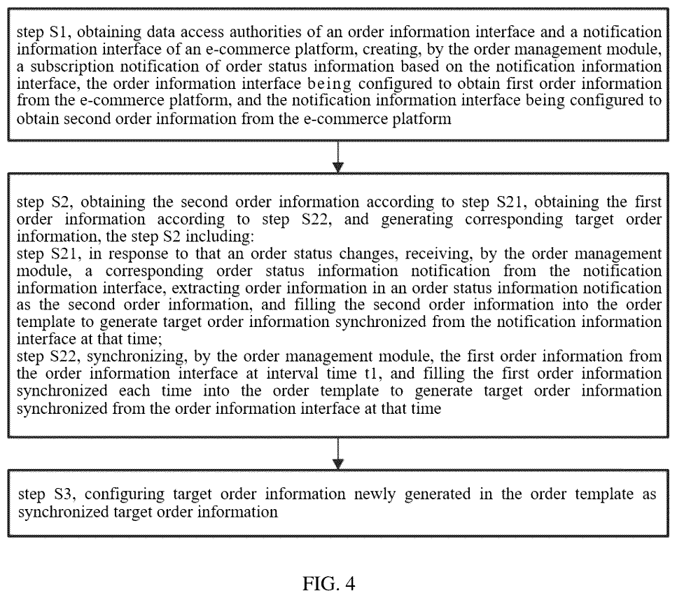

As shown in FIG. 1 to FIG. 4, the present application proposes a method for synchronizing order information, which is used for an order management module of THE e-commerce ERP, and the order management module includes an order template for storing order information. The method includes the following steps S1 to S3.

Step S1, obtaining data access authorities of an order information interface and a notification information interface of an e-commerce platform, creating, by the order management module, a subscription notification of order status information based on the notification information interface. The order information interface is configured to obtain first order information from the e-commerce platform, and the notification information interface is configured to obtain second order information from the e-commerce platform. The order information interface is the order information output interface of the e-commerce platform, and the notification information interface is the notification information output interface of the e-commerce platform.

Step S2, obtaining the second order information according to step S21, obtaining the first order information according to step S22, and generating corresponding target order information. The step S2 includes following steps.

Step S21, in response to that an order status changes, receiving, by the order management module, a corresponding order status information notification from the notification information interface, extracting order information in an order status information notification as the second order information, and filling the second order information into the order template to generate target order information synchronized from the notification information interface at that time.

Step S22, synchronizing, by the order management module, the first order information from the order information interface at interval time t1, and filling the first order information synchronized each time into the order template to generate target order information synchronized from the order information interface at that time.

Step S3, configuring target order information newly generated in the order template as synchronized target order information. That is, the target order information last updated in the order template is selected as the target order information after synchronization of the order, namely, as the order information that is actually effective.

Further, in step S2, each time the first order information is filled into the order template, the first order information covers the corresponding field content of the order template. Each time the second order information is filled into the order template, the second order information covers the corresponding field content of the order template, so that the order template can collect the latest first order information and the latest second order information in time. When the first order information or the second order information is filled into the order template, if the first order information or the second order information is the same as the order information content in the order template, the order information in the order template is maintained. If the first order information or the second order information is different from the order information content in the order template, the different order information is filled into the order template. The order template includes the complete order information field name and the content corresponding to each field name. Before the order template is filled for the first time, the content corresponding to each field name is empty.

Further, the order management module monitors the order status in the second order information. When the order status in the second order information is a canceled order, the order management module performs a shipment interception operation on the commodity of the canceled order, such as automatically prohibiting the generation of a shipment order and reminding the operator of the shipment risk.

Moreover, the e-commerce ERP further includes a commodity module storing commodity information, and the order management module is further provided with an information filling module. The commodity information in the first order information is defined as the first commodity information, and the commodity information in the second order information is defined as the second commodity information. The commodity information stored in the commodity module of the e-commerce ERP is defined as the third commodity information. Step S21 further includes:

determining, by the information filling module, whether the order template lacks commodity information; in response to that the order template lacks commodity information, obtaining, by the information filling module, commodity information of a corresponding field name from the third commodity information according to the second commodity information and a field name missing commodity information, and filling obtained commodity information of a corresponding field name into the order template, so that the commodity information in the order template is completed. For example, when the second order information is first obtained, since the synchronization time of the first order information is later than the synchronization time of the second order information, the order template does not have detailed commodity information (missing commodity information) at this time. In this case, the information filling module can retrieve the missing commodity information from the commodity module of the e-commerce ERP according to the online commodity code MSKU (or other commodity information) in the second commodity information and fill it into the order template, so as to complete the missing commodity information (such as commodity number ASIN, commodity specification attributes, and the like). When the order template does not lack commodity information, there is no need to retrieve commodity information from the commodity module of the e-commerce ERP.

In addition, since the notification information interface can independently provide order information, the synchronization interval time t1 of the order information interface can be correspondingly extended to reduce the risk of the order information interface synchronizing over the limit of order information interface overrun. Therefore, the synchronization interval time t1 of the order information interface can be greater than or equal to 30 minutes.

Further, when the order management module synchronizes the first order information from the order information interface for the first time, the first commodity information in the first order information is filled into the order template, replacing the original third commodity information in the order template.

In addition, some e-commerce platforms further provide an order report interface. Since the order report interface of the e-commerce platform can only be generated after the order-related stage is completed, the order information output by the order report interface will be relatively delayed and cannot solve the problem of accelerating the synchronization of order information. However, since the order report interface can be requested in batches, there will be a problem of the interface exceeding the limit and missing order. In this case, if the synchronization interval time of the first order information is set very long, before the first order information is obtained for the first time, the corresponding order information (including detailed order information and complete order commodity information) can be obtained from the order report to make up for the defect that the second order information lacks a lot of order information. The specific implementation is as follows.

The e-commerce platform further includes an order report interface (defined as a third interface). In step S1, a data access authority of the order report interface is obtained, and the order report interface is configured to obtain the third order information from the e-commerce platform. In step S2, the order management module is configured to synchronize the third order information from the order report interface at interval time t3, and the third order information synchronized each time is filled into the order template to generate the target order information synchronized from the order information interface at that time. Since the order report interface has no overlimit problem, the synchronization interval time t3 of the order report interface can be set to about 5 minutes, so that the system can fill the detailed order information into the order template as soon as possible before obtaining the first order information for the first time, thereby improving the accuracy of the order information.

Further, the order management module further includes a time control module, which monitors the synchronization time of the order information interface and the synchronization time of the notification information interface. When the order information interface obtains the first order information and the notification information interface obtains the second order information simultaneously, the order management module is configured to lock order information synchronization of the order information interface, and restore the order information synchronization of the order information interface after the notification information interface completes current synchronization, so as to prevent the order template from being filled with the first order information and the second order information simultaneously, thereby improving the stability of data filling.

In one embodiment, the time control module is configured to record a time t0 when the second order information is first obtained, and the time control module is configured to judge whether the order template is filled with the first order information at interval time t0+t1+t4. When the order template does not include the first order information at interval time t0+t1+t4, it is determined that there is a missing order in the order information interface, and t4 is a preset information transmission time for the order information interface receiving order information. When the order template includes the first order information at the interval time t0+t1+t4, it is determined that there is no missing order in the order information interface. Based on the order data output by the notification information interface, it is verified whether there is a missing order in the order information interface, thereby improving the stability and security of order information synchronization.

Further, the order management module further includes an order list. When the order management module determines that there is a missing order in the order information interface, a missing order prompt is generated in the order list. The missing order includes the order information in the second order information.

In addition, in one embodiment, the order management module collects the order information of different orders in the order list, so as to facilitate the centralized management and display of the order information. The order list can further be provided with a manual synchronization key. After selecting the corresponding order, the order information of the corresponding order can be immediately synchronized through the directional information interface by clicking the manual synchronization key, so as to facilitate the operator to actively synchronize the order information.

In other embodiments, when the order management module determines that there is a missing order in the order information interface, counting the number of orders N1 that need to be synchronized within the time period (defined as the missing order time period) corresponding to the synchronization interval time t1 of the missing order. The number of orders N1 includes the sum of the number of orders n1 of the missing order and the number of orders n2 of the normal synchronization order information, that is, N1=n1+n2. Further, the number of orders N1 that need to be synchronized for other multiple missing orders in the missing order time period, and the minimum value N1min is used as the maximum number of orders of the order information interface corresponding to the synchronization interval time t1. In addition, the order management module estimates the number of orders N in each interval time t1, and N can be estimated as twice the number of orders in the first half of the interval time t1. When N is greater than N1min, the synchronization interval time t1 of the order information interface is automatically extended to t1′, t1′=(N/N1min)*t1. Therefore, the interval time t1 is automatically extended during the peak order period, to prevent the order information interface from exceeding the limit.

The above are only some embodiments of the present application, and do not limit the scope of the present application thereto. Under the concept of this application, any equivalent transformation made according to the description and drawings of the present application, or direct/indirect application in other related technical fields shall fall within the claimed scope of the present application.

What is claimed is:

1. A method for synchronizing order information, applied to an order management module of e-commerce enterprise resource planning (ERP), wherein the order management module comprises an order template, and the method comprises:
step S1, obtaining data access authorities of an order information interface and a notification information interface of an e-commerce platform, and creating, by the order management module, a subscription notification of order status information based on the notification information interface, wherein the order information interface is configured to obtain first order information from the e-commerce platform, and the notification information interface is configured to obtain second order information from the e-commerce platform;
step S2, obtaining the second order information according to step S21, obtaining the first order information according to step S22, and generating corresponding target order information, wherein the step S2 further comprises:
step S21, when an order status changes, receiving, by the order management module, a corresponding order status information notification from the notification information interface, extracting order information in an order status information notification as the second order information, and filling the second order information into the order template to generate target order information synchronized from the notification information interface at that time;
step S22, synchronizing, by the order management module, the first order information from the order information interface at an interval time t1, and filling the first order information synchronized each time into the order template to generate target order information synchronized from the order information interface at that time; and
step S3, configuring target order information newly generated in the order template as synchronized target order information.

2. The method for synchronizing order information according to claim 1, wherein the e-commerce ERP further comprises a commodity module storing commodity information, the order management module is further provided with an information filling module, commodity information in the first order information is defined as first commodity information, commodity information in the second order information is defined as second commodity information, commodity information stored in the e-commerce ERP commodity module is defined as third commodity information, and step S21 further comprises:
determining, by the information filling module, whether the order template lacks commodity information; and
when the order template lacks commodity information, obtaining, by the information filling module, commodity information of a corresponding field name from the third commodity information according to the second commodity information and a field name missing commodity information, and filling obtained commodity information of a corresponding field name into the order template.

3. The method for synchronizing order information according to claim 2, wherein the synchronization interval time t1 of the order information interface is not less than 30 minutes.

4. The method for synchronizing order information according to claim 2, further comprising when the order management module synchronizes the first order information from the order information interface for a first time, filling the first commodity information in the first order information into the order template to replace original third commodity information in the order template.

5. The method for synchronizing order information according to claim 1, wherein the e-commerce platform further comprises an order report interface, a data access authority of the order report interface is obtained in step S1, and the order report interface is configured to obtain the third order information from the e-commerce platform;
in step S2, the order management module is configured to synchronize the third order information from the order report interface at an interval time t3, and the third order information synchronized each time is filled into the order template to generate the target order information synchronized from the order information interface at that time.

6. The method for synchronizing order information according to claim 1, wherein:
the order management module further comprises a time control module, and the time control module is configured to monitor the synchronization time of the order information interface and the notification information interface; and
when the order information interface obtains the first order information and the notification information interface obtains the second order information simultaneously, the order management module is configured to lock order information synchronization of the order information interface, and restore the order information synchronization of the order information interface after the notification information interface completes current synchronization.

7. The method for synchronizing order information according to claim 6, wherein:
the time control module is configured to record a time t0 when the second order information is first obtained, and the time control module is configured to judge whether the order template is filled with the first order information at interval time t0+t1+t4; and
when the order template does not include the first order information at interval time t0+t1+t4, determining that there is a missing order in the order information interface, and t4 is a preset information transmission time for the order information interface receiving order information.

8. The method for synchronizing order information according to claim 7, wherein the order management module further comprises an order list, and when it is determined that there is a missing order in the order information interface, a missing order prompt is generated in the order list.

9. The method for synchronizing order information according to claim 1, wherein:
in step S2, each time the first order information is filled into the order template, the first order information is configured to cover corresponding field content of the order template, each time the second order information is filled into the order template, the second order information is configured to cover the corresponding field content of the order template; and/or
the order management module is configured to monitor an order status in the second order information, and when the order status in the second order information is a canceled order, the order management module is configured to perform a shipment interception operation on a commodity of the canceled order.

10. An e-commerce ERP, comprising an order management module, wherein the order management module is configured to execute the method for synchronizing order information according to claim 1.
